(19) United States
(12) Patent Application Publication
(10) Pub. No.: US 2009/0165748 A1
(43) Pub. Date: Jul. 2, 2009

(54) PETROLEUM FUEL SUPPLY METHOD AND CIRCUIT

(76) Inventors: Kazunori Yamamoto, Saga-Prefecture (JP); Tokuzou Yamamoto, Saga-Prefecture (JP)

Correspondence Address: BURR & BROWN, PO BOX 7068, SYRACUSE, NY, 13261-7068, US

(21) Appl. No.: 12/091,806

(22) PCT Filed: Apr. 3, 2006
(86) PCT No.: PCT/JP2006/307029

§ 371 Date: Nov. 12, 2008

(30) Foreign Application Priority Data
Oct. 28, 2005 (JP) 2005-342820

(51) Int. Cl. F02M 63/00

(52) U.S. Cl. 123/447; 123/459

(57) ABSTRACT

A fuel supply method and circuit including at least one flow-rate regulating valve is provided at a return pipe for returning excess return fuel from a combustion chamber side. During the combustion operation, the fuel from the supply pipe is supplied to a fuel injection nozzle with the return pipe closed or restricted to a predetermined opening degree and the back pressure of the return pipe raised by at least one flow-rate regulating valve. The fuel is supplied to the fuel injection nozzle as being pressurized by the return back pressure, so that the fuel injection nozzle supplies to the combustion chamber the fuel that has been heated to a high-temperature. The return fuel is circulated from the return pipe directly through the supply pipe, and mixed in a sub-tank with low-temperature fuel from a fuel tank. The mixed fuel is supplied to the fuel injection nozzle.

### TECHNICAL FIELD

The present invention relates to a method and a circuit for supplying petroleum-fuel and, in particular, to petroleum fuel supply method and circuit whereby fuel to be supplied to a combustion chamber of a diesel engine or the like into a state suitable for a complete combustion.

### BACKGROUND ART

For example, in gasoline engine for automobiles, there is generally performed a method for improving combustion of gasoline fuel or a method for decreasing emission of harmful substances (CO, HC, NOx) in the exhaust gas by a catalyst.

In order to improve combustion efficiency of fuel, there is proposed to preliminarily reform the fuel to be supplied to a combustion chamber of an engine, by providing a catalytic material made of metal, ceramics or the like, at as inside of an existing fuel tank. However, many of these measures have no confirmed practical effects.

In diesel engine running on diesel oil, a prominent problem is emission of black smoke containing carbon or HC that occurs especially due to incomplete combustion. However, in terms of the fuel property, a conventional catalyst for exhaust-gas purification alone cannot sufficiently solve the problem. Especially in combination with conventional-type engine, an economical and positive countermeasure has not been found, which can easily solve the above-mentioned problem.

The inventors have previously proposed a method in which fuel from the fuel tank is preliminarily heated to a temperature within a predetermined range and supplied to the combustion chamber of a diesel engine or the like, in at least partially vaporized state (WO00/71883A1). According to this proposal, in the case of a diesel engine, for example, there is supplied diesel oil from the fuel tank to the combustion chamber as being preliminarily heated to a temperature within a range of 30° C. to 300° C., over a substantially entire combustion period.

### DISCLOSURE OF THE INVENTION

### Task to be Solved by the Invention

However, the above-mentioned proposal requires a heating source that heats the diesel oil to be supplied through a supply pipe to the combustion chamber.

It is an object of the present invention to provide fuel supply method and circuit capable of reforming petroleum fuel to be supplied to a combustion chamber of gasoline engine, diesel engine or the like, into a state suitable for complete combustion, without requiring any special heating source, before it is supplied to the combustion chamber.

It is another object of the present invention to provide fuel supply method and circuit capable of dramatically improving fuel consumption of the petroleum fuel and significantly decreasing emission of harmful substances in exhaust gas.

### Means for Solving the Task

The objects of the present invention can be achieved by a petroleum fuel supply method for supplying petroleum fuel from a fuel tank to a fuel injection nozzle via a fuel pump through a supply pipe, wherein excess return fuel is returned from said fuel injection nozzle to said fuel tank through a return pipe, said return pipe being provided with one or more flow-rate regulating valves in midstream thereof, wherein the petroleum fuel is supplied from said supply pipe to said fuel injection nozzle with some or all of said flow-rate regulating valves closed or restricted to have a predetermined opening degree, during combustion operation.

The objects of the present invention can also be achieved by a petroleum fuel supply circuit comprising a supply pipe for supplying petroleum fuel from a fuel tank to a fuel injection nozzle via a fuel pump, and a return pipe for returning excess return fuel from said fuel injection nozzle to said fuel tank, wherein one or more flow-rate regulating valves are disposed at said return pipe.

In diesel engine running on diesel oil, the diesel oil supplied to the fuel injection nozzle is directly injected into a combustion chamber. Furthermore, in gasoline engine running on gasoline, gasoline fuel is supplied to the fuel injection nozzle and injected into the combustion chamber, as a mixture with air.

Excess fuel, which has not been used in combustion, is flown into the return pipe as the return fuel from the fuel injection nozzle. On this occasion, according to the present invention, one or more flow-rate regulating valves provided for the return pipe are either completely closed or restricted to have a predetermined opening degree so as to raise the return back pressure inside the return pipe during the combustion period, thereby increasing the pressure of the fuel in the fuel injection nozzle. Further, the return back pressure slows down the flow of the return fuel to retain the fuel in the fuel injection nozzle for a longer period of time, so that the temperature of the fuel in the fuel injection nozzle is naturally elevated due to the engine combustion heat.

In other words, by either closing one or more flow-rate regulating valves provided for the return pipe or restricting them to have a predetermined opening degree, the fuel in the fuel injection nozzle can be injected therefrom into the combustion chamber as significantly minute particles (microparticles) in a high-pressure high-temperature state close to, for example, 100° C. so as to be combusted in a short period of time. During the combustion period, the combustion chamber is in a significantly high-temperature state of approximately 500° C., so that the injection from the fuel injection nozzle of the fuel heated up to a high temperature of approximately 100° C. leads to an instantaneous (1/1,000 to 3/1,000 minutes) gasification thereof in the combustion chamber, thereby allowing a more complete combustion.

It is to be noted that the heating makes the diesel oil used as the fuel for the diesel engine volatile to be easily gasified. Thus, when the diesel oil heated to a temperature up to approximately 100° C. is injected from the fuel injection nozzle into the combustion chamber at a temperature of approximately 500° C., the diesel oil is spontaneously gasified in the combustion chamber so as to be more completely combustible promptly, in combination with surrounding oxygen. This is the key for effectively reducing incomplete combustion due to insufficient gasification during combustion, minimizing emission of the resultant C, HC, CO or the like as the product of back smoke or incomplete combustion, and significantly improving the fuel consumption.

Additionally, in the case of diesel engine, the excess return fuel from the fuel pump is merged into the return pipe via the sub-return pipe. The flow-rate regulating valve on the downstream side relative to a merging section is closed, or retained at a predetermined opening degree, thereby raising the internal pressure in the sub-return pipe and the fuel pressure in the fuel pump. Accordingly, fuel with higher pressure and temperature can be supplied to the fuel injection nozzle. In combination with such an advantageous effect, it is possible to reform the fuel in the fuel injection nozzle into a more completely combustible state.

It is desirable that a bypass passage for bypassing the flow-rate regulating valve be provided in the midstream of the return pipe. In other words, it is desirable that the return fuel be guided into the bypass passage by operating an associated relief valve, when the internal pressure in the return pipe exceeds a predetermined level due to the closure or the like of the flow-rate regulating valve. This makes it possible to relieve undue pressure exerted on the fuel injection nozzle or the fuel pump, to each of which the return pipe is connected, and to thereby prevent the nozzle or the pump from being damaged.

For example, in a common-rail type diesel engine, the fuel pump feeds the fuel into the combustion chamber while pressurizing the fuel with considerably high pressure (e.g., approximately 180 MPa). On this occasion, if the flow-rate regulating valve is excessively closed, the pressure of the return fuel flowing through the sub-return pipe rises sharply with the result that an undue load is likely to affect on the fuel pump. The provision of the above-mentioned bypass passage and relief valve serves positively to prevent the fuel pump from damaging due to the undue load affecting on the fuel pump.

The return fuel returned from the fuel injection nozzle into the return pipe (in the case of diesel engine, inclusive of the return fuel from the fuel pump heated by adiabatic compression, fictional heat, etc.) has already been heated to a high temperature by the above-mentioned two effects, so that it is desirable to feed the high-temperature return fuel directly into the supply pipe.

From the viewpoint of the foregoing, it is desirable to connect the midstream of the return pipe to the supply pipe by means of a circulation pipe. This allows the high-temperature return fuel to be fed from the circulation pipe directly into the supply pipe, without requiring any special heating source.

The high-temperature return fuel from the circulation pipe can be sufficiently mixed with the fuel from the fuel tank, in a sub-tank that is provided in the midstream of the supply pipe and connected to an outlet of the circulation pipe. The fuel sufficiently mixed in the sub-tank can be supplied to the fuel injection nozzle as high-temperature fuel.

The present invention can also be applied to gasoline engines that using gasoline as the fuel. The initial boiling point of gasoline is approximately 29.0° C., so that approximately 10% thereof vaporizes at a temperature of 50° C., and approximately 50% thereof does at a temperature of 90° C. According to experimental study, an apparent improvement effect has already been confirmed at a temperature of 30° C. serving as a reference temperature. On the other hand, even when gasoline is heated up to a temperature of approximately 90° C., a safety combustion by the engine was confirmed by the experiment. Accordingly, the heating temperature range of gasoline in the present invention was set to be within a range of 30° C. to 90° C. However, the method according to the present invention may also be applied to a case where gasoline is heated to temperature exceeding the above-mentioned upper limit temperature of 90° C.

Similarly to the case of diesel engine, the fuel in the fuel injection nozzle a high-pressure and high-temperature state can be injected into the combustion chamber as being sufficiently mixed with air, and combusted in a more completely combustible state by means of ignition of vaporized fuel with spark from a spark plug.

In the case of boiler or the like combustion apparatus running on coal oil or heavy oil, either the closure of the flow-rate regulating valve or the retaining thereof to a certain opening degree serves to raise the internal pressure in the return pipe, so that the fuel is fed into the combustion chamber in a high-pressure and high-temperature state. The term “combustion chamber” may be used to encompass a burner. It is to be noted that in the case of heavy oil group, the heating to a temperature of 30° C. or higher can fluidize the fuel, though a temperature much higher than the fluidization temperature is desirably used.

### Effects of the Invention

According to the present invention, the return pipe is provided with one or more flow-rate regulating valves in midstream thereof, and the petroleum fuel is supplied from the supply pipe to the fuel injection nozzle with some or all of the flow-rate regulating valves closed or restricted to have a predetermined opening degree, during combustion operation. Therefore, the present invention provides a functional advantage that the petroleum fuel can be supplied to the combustion chamber of the gasoline engine, diesel engine or the like, after it has been reformed into a completely combustible state without requiring any special heating source.

### BRIEF DESCRIPTION OF THE DRAWINGS

The present invention will be described below in further detail, with reference to the accompanying drawings, wherein:

FIG. 1 is an explanatory view showing a fuel supply circuit according to one embodiment of the present invention as applied to a diesel engine automobile;

FIG. 2 is an explanatory view showing a fuel supply circuit according to another embodiment of the present invention also as applied to a diesel engine automobile;

FIG. 3 is an explanatory view showing a variation where a plurality of flow-rate regulating valves are arranged in the supply circuit in FIG. 2; and

FIG. 4 is an explanatory view showing a conventional fuel supply circuit of a diesel engine.

### REFERENCE NUMERALS

1 Fuel tank
2 Supply pipe
3 Filter
4 Fuel pump
5 Fuel injection nozzle
6 Combustion chamber
7 Return pipe
8 Merging section
9 Sub-return pipe
10, 19, 20, 21 Flow-rate regulating valves
11 Bypass passage
12 Relief valve
13 Piston
14, 15 Thermometers
16 Guide branch
17 Circulation pipe
18 Sub-tank

### BEST MODE FOR CARRYING OUT THE INVENTION

The present invention will be further explained below with reference to some preferred embodiments.

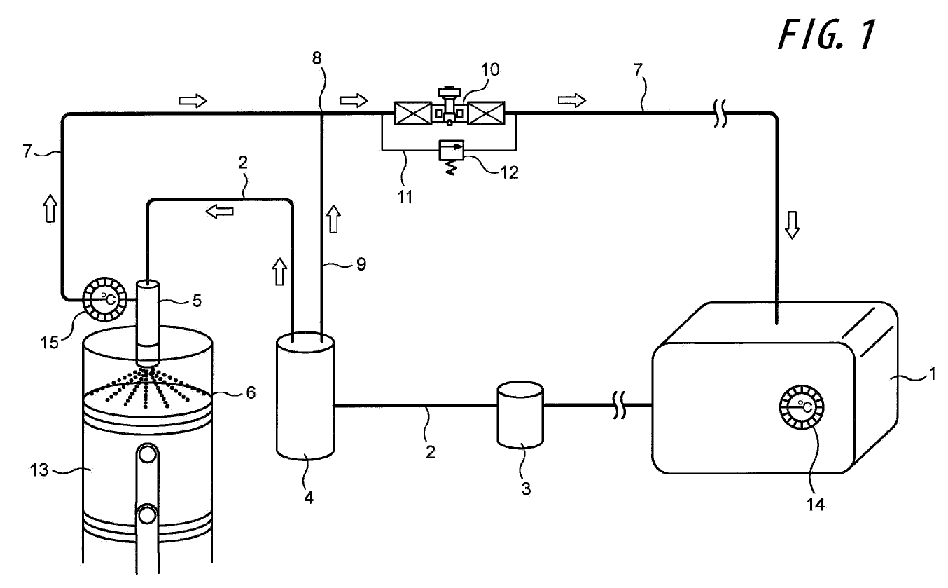

As shown in FIG. 1, a fuel supply circuit for a diesel engine is typically comprised of an automobile fuel tank 1 that is connected to a fuel injection nozzle 5 mounted on a combustion chamber 6, by a supply pipe 2 extending from the fuel tank toward the automobile engine side, via a filter 3 and a fuel pump 4 both arranged at the zones adjacent to the engine. There is provided a return pipe 7 for returning excess return fuel, which has not been used in combustion. The return pipe 7 extends from the fuel injection nozzle 5 to the fuel tank 1 side adjacent to the fuel tank of the automobile. There is further provided a sub-return pipe 9 for merging the excess return fuel, which has not been supplied to the fuel injection nozzle 5. The sub-return pipe 9 extends from the fuel pump 4 to a merging section 8 of the return pipe 7.

In the illustrated embodiment of the present invention, the return pipe 7 is provided with a first flow-rate regulating valve 10 on the fuel tank 1 side relative to the sub-return pipe 9 in the zone adjacent to the automobile engine. The flow-rate regulating valve 10 is capable of setting an opening degree within a range of 0% to 100% by means of a valve body inside a pipe body. Thus, by either closing the inside of the pipe body (closure degree of 100%) or restricting it to a certain degree (closure degree, e.g., of only 50%), it is possible to increase the internal pressure inside the return pipe 7 on the combustion chamber 6 side and the fuel pressure inside the fuel injection nozzle 5 by the return back pressure, and also to increase the internal pressure inside the sub-return pipe 9 and the fuel pressure (fuel supply pressure) inside the fuel pump 4 by the return back pressure. In terms of the structure, the flow-rate regulating valve 10 may be comprised of a needle valve, a butterfly valve, a glove valve, or the like.

A bypass passage 11 is disposed to extend from the upstream side of the flow-rate regulating valve 10 (on the fuel injection nozzle 5 side) to the downstream side thereof (on the fuel tank 1 side). The bypass passage 11 has an inlet that is connected to the return pipe 7 at a location between the flow-rate regulating valve TO and the merging section 8 of the sub-return pipe 9. The bypass passage 11 has an outlet that is connected to the return pipe 7 between the flow-rate regulating valve 10 and the fuel tank 1. A relief valve 12 is provided in the midstream of the bypass passage 11, and configured so that it can be restricted to have a desired opening degree. Thus, when the pressure exceeding a predetermined level occurs in the return pipe 7 on the combustion chamber 6 side, the relief valve 12 automatically operates to guide the fuel flowing through the return pipe 7 into the bypass passage 11 in front of the flow-rate regulating valve 10. The relief valve 12 ensures that the fuel bypasses the flow-rate regulating valve 10 so as to be returned into the return pipe 7.

It is to be noted that reference numeral 13 denotes a piston that vertically moves inside the combustion chamber 6, reference numeral 14 denotes a thermometer for measuring the fuel temperature inside the fuel tank 1, and reference numeral 15 denotes a thermometer located around an outlet pipe of the fuel injection nozzle 5 for measuring the fuel temperature inside the fuel injection nozzle 5.

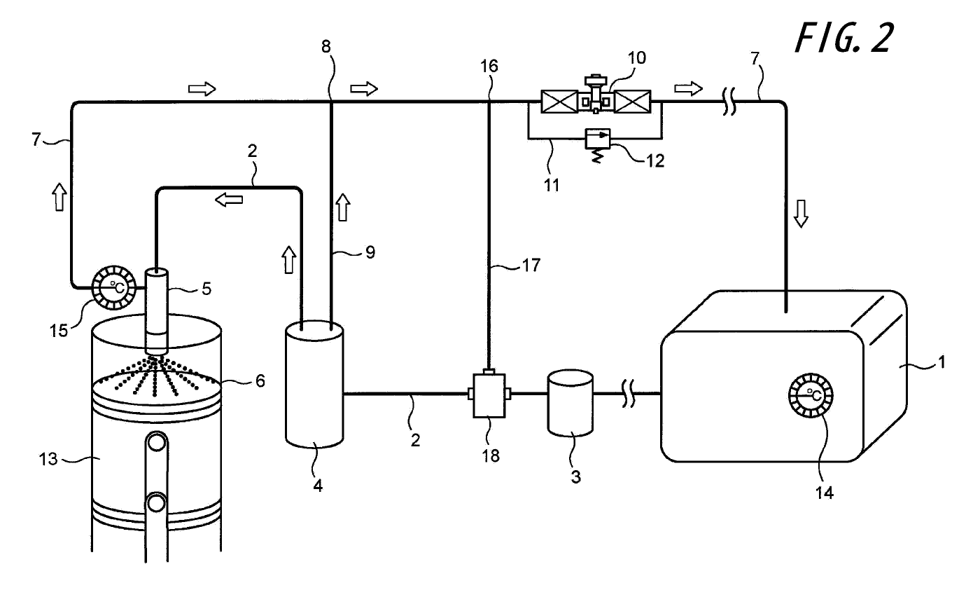

FIG. 2 shows another embodiment of the present invention, wherein the same reference numerals are used to denote to functionally the same or corresponding elements as those in FIG. 1, in order to omit superfluous explanation.

The fuel supply circuit as shown in FIG. 2 is provided with a circulation pipe 17 having an inlet that is connected to a guide branch 16 of the return pipe 7 between the merging section 8 of the sub-return pipe 9 and the flow-rate regulating valve 10, at the zone adjacent to the automobile engine. The circulation pipe 17 has an outlet connected to a sub-tank 18, which is positioned at the zone adjacent to the automobile engine. The sub-tank 18 is provided in the midstream of the supply pipe 2, i.e., between the filter 3 and the fuel pump 4. Thus, by closing the flow-rate regulating valve 10 located on the fuel tank 1 side of the guide branch 16 or restricting it to a desired opening degree, it is possible to guide all or some portion of the high-temperature return fuel flowing through the return pipe 7, from the guide branch 16 into the circulation pipe 17 to sufficiently mix the return fuel with the low-temperature fuel from the fuel tank 1. The high-temperature fuel so obtained in the sub-tank 18 is supplied to the fuel injection nozzle 5 via the fuel pump 4.

Most of the return fuel flowing through the return pipe 7 is guided into the circulation pipe 17 and circulated between the supply pipe 2 and the return pipe 7, thereby ensuring that the high-temperature fuel can be supplied to the fuel injection nozzle 5 at all times. Additionally, the more the return fuel is consumed, the less the low-temperature fuel is supplied from the fuel tank 1. As a result, the flow speed of the fuel flowing through the supply pipe 2 is lowered, and the pipe friction coefficient of the fuel can be decreased, so that the fuel can be smoothly supplied.

The circulation pipe 17 and the sub-tank 18 are arranged near the fuel pump 4 relative to the filter 3, as mentioned above, because the return fuel flowing through the return pipe 17 has passed through the filter once and it is thus not required for the return fuel to pass therethrough again. Another reason for adopting this arrangement is that the filter is thereby prevented from damaging due to the passage of the high-temperature fuel.

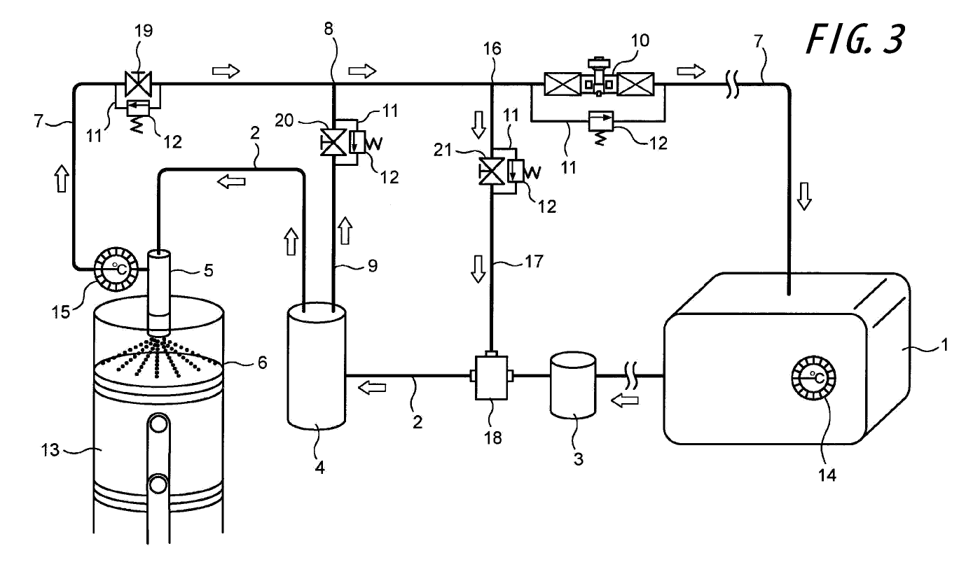

There is shown in FIG. 3 an example of the fuel supply circuit in which a plurality of flow-rate regulating valves are arranged in the pipe system including the return pipe 7. As show in FIG. 3, the flow-rate regulating valve 10 is disposed on the fuel tank 1 side of the return pipe 7 relative to the guide branch 16. A second flow-rate regulating valve 19 is disposed between the merging section 8 of the sub-return pipe 9 and the fuel injection nozzle 5. A third flow-rate regulating valve 20 is disposed in the midstream of the circulation pipe 17. A fourth flow-rate regulating valve 21 is disposed in the midstream of the sub-return pipe 9. The flow-rate regulating valves 10, 19, 20 and 21 can be each used in any combination so as to allow closing or restriction of some or all of them to the respectively desired opening degrees. It is to be noted that the flow-rate regulating valves 10, 19, 20 and 21 are each provided with the bypass passage 11 and the relief valve 12 both shown in FIG. 1.

For example, in a first mode, all of the return fuel can be circulated between the return pipe 7 and the supply pipe 2 with only the flow-rate regulating valve 10 closed (closure degree of 100%). In a second mode, only the return fuel from the fuel pump 4 can be circulated with the flow-rate regulating valves 10 and 19 closed. In a third mode, only the return fuel from the fuel injection nozzle 5 can be circulated with the flow-rate regulating valves 10 and 20 closed. Finally, in a forth mode, the fuel pressure and the fuel temperature inside the fuel injection nozzle 5 can also be further raised with all of the flow-rate regulating valves 10, 19, 20, and 21 closed, i.e., without any return of the return fuel. With respect to these flow-rate regulating valves, the opening degree can also be suitably adjusted (e.g., closure degree of only 50% or only 10%), corresponding to the type or various performances of the engine to which the present invention is be applied.

### EXAMPLE 1

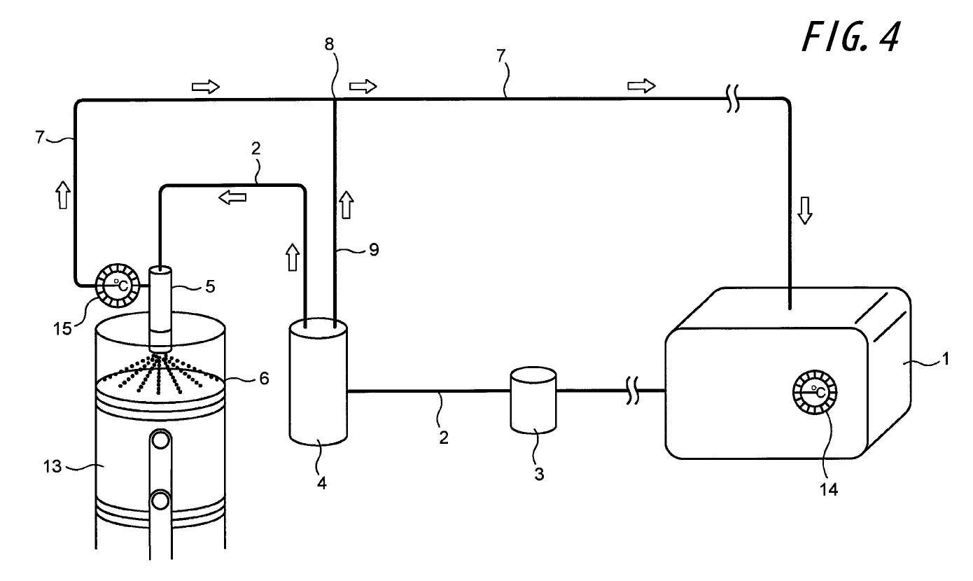

An automobile mounting a diesel engine having a displacement of 2,500 cc and employing the fuel supply circuit according to the present invention shown in FIG. 1 has been subjected to a test running in a general manner. The travel distance per litter of the fuel was measured, and the fuel consumption was calculated based on the measured data. With reference to the data of a comparative experiment wherein the fuel temperature was 30° C. and the fuel consumption was 7 km/litter, when the flow-rate regulating valve 10 in FIG. 1 was closed at a closure degree of 50%, the fuel temperature was raised to 50° C. and the fuel consumption was 9 km/litter, which means that the fuel consumption was improved by 29% with reference to the control data. Furthermore, when the flow-rate regulating valve 10 in FIG. 1 was closed at a closure degree of 100%, the fuel temperature was raised to 67° C. and the fuel consumption was 11 km/litter, which means that the fuel consumption was improved by 57% with reference to the control data. In any case, it has been confirmed that a significant improvement in fuel consumption could be achieved in comparison to the conventional arrangement (control data). It is to be noted that the comparative experiment has been conducted using an automobile mounting the same diesel engine of 2,500 cc displacement and employing a general fuel supply circuit shown in FIG. 4. Furthermore, the fuel temperature refers to the temperature inside the fuel injection nozzle.

### EXAMPLE 2

An automobile mounting a diesel engine having a displacement of 2,500 cc and employing the fuel supply circuit of the present invention shown in FIG. 2 has been subjected to a test running. The travel distance per litter of the fuel was measured, and the fuel consumption was calculated based on the measured data. With reference to the data of the comparative experiment wherein the fuel temperature was 30° C. and the fuel consumption was 7 km/litter, when half of the return fuel was fed into the sub-tank 18 and the mixed fuel with the fuel from the fuel tank 1 was thus supplied to the fuel injection nozzle 5 with the flow-rate regulating valve in FIG. 2 closed at a closure degree of 50%, the fuel temperature was raised to 60° C. and the fuel consumption was 10 km/litter, which means that the fuel consumption was improved by 42% with reference to the control data. Furthermore, when all of the return fuel was fed into the sub- tank 18 and the mixed fuel with the fuel from the fuel tank 1 was thus supplied to the fuel injection nozzle 5 with the flow-rate regulating valve 10 in FIG. 2 closed at a closure degree of 100%, the fuel temperature was raised to 67° C. and the fuel consumption was 12 km/litter, which means that the fuel consumption was improved by 71% with reference to the control data. In any case, it has been confirmed that a significant improvement in fuel consumption could be achieved also, in comparison to the conventional arrangement (control data). It is to be noted that the comparative experiment has been conducted using an automobile mounting the same diesel engine of 2,500 cc displacement and employing a general fuel supply circuit shown in FIG. 4. Here also, the fuel temperature refers to the temperature inside the fuel injection nozzle.

As apparent from the above-mentioned results, the present invention makes it possible to improve the combustion in the automobile or the like running on diesel oil, and thus significantly improves the fuel consumption. Further, the present invention has no necessity other than to mount the flow-rate regulating valve 10, circulation pipe 17, sub-tank 18 etc., and does not require any huge reform or the like.

In the foregoing, the present invention has been explained with reference to some preferred embodiments. However, the shapes, mounted positions, etc., of the respective constituent elements are not restricted to those illustrated in the drawings, and various design changes or modifications may be made within the scope of the invention.

### INDUSTRIAL APPLICABILITY

The present invention effectively reforms the petroleum fuel, per se, to improve the combustion efficiency, thereby enabling a complete combustion to be realized, and significantly improving the fuel consumption without posing any risk or problem to the operation of a combustion apparatus. The present invention is applicable to petroleum fuel including gasoline, diesel oil (coal oil, jet fuel), heavy oil or the like, and is also applicable to LPG (Liquefied Petroleum Gas) which is included in fossil fuel in a broad sense.

1-9. (canceled)

10. A petroleum fuel supply method for supplying petroleum fuel for a diesel engine from a fuel tank to a fuel injection nozzle via a fuel pump through a supply pipe, wherein excess return fuel is returned from said fuel injection nozzle to a fuel tank side through a return pipe, a first flow-rate regulating valve being disposed in midstream of said return pipe and the midstream of said return pipe at a fuel injection nozzle side relative to said first flow-rate regulating valve being connected to said supply pipe using a circulation pipe, wherein all of the return fuel flowing in said return pipe is fed into said supply pipe directly through said circulation pipe with said first flow-rate regulating valve closed, mixed fuel of the return fuel and the fuel from said fuel tank is supplied, during combustion operation, to said fuel injection nozzle.

11. The petroleum fuel supply method according to claim 10, wherein the return fuel is guided into a bypass passage by operating an associated relief valve, when an internal pressure in said return pipe exceeds a predetermined level due to the closure of said first flow-rate regulating valve, said bypass passage being provided for bypassing said first flow-rate valve at its disposed position.

12. A petroleum fuel supply circuit comprising a supply pipe for supplying petroleum fuel for a diesel engine from a fuel tank to a fuel injection nozzle via a fuel pump, a return pipe for returning excess return fuel from said fuel injection nozzle to a fuel tank side, a first flow-rate regulating valve disposed in midstream of said return pipe, and a circulation pipe having an inlet connected to said return pipe at a fuel injection nozzle side relative to said first flow-rate regulating valve and an outlet connected to said supply pipe, wherein all of the return fuel flowing through said return pipe is fed into said supply pipe directly through said circulation pipe, so that mixed fuel of the return fuel and the fuel from said fuel tank is supplied, during combustion operation, to said fuel injection nozzle.

13. The petroleum fuel supply circuit according to claim 12, wherein the return fuel is guided into a bypass passage by operating an associated relief valve, when an internal pressure in said return pipe exceeds a predetermined level due to the closure of said first flow-rate regulating valve, said bypass passage being provided for bypassing said first flow-rate valve at its disposed position.

14. The petroleum fuel supply method according to claim 10, wherein the return fuel from said fuel injection nozzle and that from said fuel pump are fed into said supply pipe directly through said circulation pipe, and the mixed fuel of the return fuel and the fuel from said fuel tank is supplied to said fuel injection nozzle during combustion operation, the supply circuit comprising a sub-return pipe having an outlet connected to said return pipe at a fuel injection nozzle side relative to said circulation pipe to merge the excess return fuel from said fuel pump with said return pipe.

15. The petroleum fuel supply method according to claim 14, wherein only the return fuel from said fuel injection nozzle is fed into said supply pipe directly through said circulation pipe, and the mixed fuel of the return fuel and the fuel from said fuel tank is supplied to said fuel injection nozzle, during combustion operation, with said first and a second flow-rate regulating valves being respectively closed, said second flow- rate regulating valve being disposed in midstream of said sub-return pipe.

16. The petroleum fuel supply method according to claim 14, wherein only the return fuel from said fuel injection nozzle is fed into said supply pipe directly through said circulation pipe, and the mixed fuel of the return fuel and the fuel from said fuel tank is supplied to said fuel injection nozzle, during combustion operation, with said first and a third flow-rate regulating valves respectively closed, said third flow-rate regulating valve being disposed in midstream of said return pipe between a merging section of said sub-return pipe and said fuel injection nozzle.

17. The petroleum supply circuit according to claim 12, further comprising a sub-return pipe having an outlet connected to said return pipe at a fuel injection nozzle side relative to said circulation pipe, for merging the excess return fuel from said fuel pump with said return pipe so that the return fuel from said fuel injection nozzle and that from said fuel pump are fed into said supply pipe directly through said circulation pipe, and the mixed fuel of the return fuel and the fuel from said fuel tank is supplied to said fuel injection nozzle during combustion operation.

18. The petroleum supply circuit according to claim 17, wherein said second flow-rate regulating valve is arranged in midstream of said sub-return pipe, and said third flow-rate regulating valve is arranged in midstream between a merging section of said sub-return pipe and said fuel injection nozzle.
